(19) United States
(12) Patent Application Publication
(10) Pub. No.: US 2007/0074770 A1
(43) Pub. Date: Apr. 5, 2007

(54) Conductive jet pump

(76) Inventors: Chris I. Witherspoon, Clarkston, MI (US); Sharon E. Beyer, Grand Blanc, MI (US); Ronald L. Williams, Linden, MI (US); James W. Jeffers, Fenton, MI (US)

Correspondence Address: DELPHI TECHNOLOGIES, INC., M/C 480-410-202, PO BOX 5052, TROY, MI, 48007, US

(21) Appl. No.: 11/240,540

(22) Filed: Sep. 30, 2005

(51) Int. Cl. B60K 15/077

(52) U.S. Cl. 137/565.22

(57) ABSTRACT

A modular fuel reservoir assembly for incorporation into a vehicle fuel tank includes a fuel reservoir, a fuel pump, a fuel filter and a retainer. The retainer is formed of an electrically conductive material and includes integrally formed and electrically conductive fuel supply and fill tubes fluidly interconnected at the open bottom ends thereof by a jet pump. The reservoir includes an internal vertical column through which the supply and fill tubes freely extend such that the jet pump is located adjacent the open bottom of the reservoir column. Fuel from the tank and bypass fuel from the reservoir travel through the fill tube and empty back into the reservoir until all fuel in the tank is depleted.

### TECHNICAL FIELD

The invention relates to a modular fuel reservoir assembly in a motor vehicle fuel tank.

### BACKGROUND OF THE INVENTION

Present day vehicle fuel systems may include an assembly commonly referred to as a “modular fuel reservoir” (MFR) assembly in the fuel tank of the motor vehicle. A typical MFR includes a tank cover, a cup-shaped plastic reservoir, a plurality of guide rods on the tank cover slidably connected to the reservoir, and a spring urging relative separation between the tank cover and the reservoir. The MFR is inserted into the fuel tank through an access port in the top of the fuel tank which is sealed closed by the tank cover and a rubber seal. The spring biases the reservoir against the bottom of the fuel tank. A plastic retainer on the top of the plastic reservoir locates a fuel pump and fuel filter in the reservoir. The electric motor of the fuel pump is turned on and off through a wiring harness of the motor vehicle. When the electric motor is on, the pump pumps fuel at elevated pressure from the reservoir through the filter, ultimately leading through the fuel lines to the vehicle engine. Vertical tubes positioned in the reservoir direct fuel from the tank, as well as fuel that has bypassed the fuel outlet of the MFR, to the reservoir wherein the pump is located. This ensures fuel surrounds the pump until the tank is close to being fully depleted of fuel.

In commonly assigned prior U.S. Pat. No. 6,216,671, a MFR is disclosed that establishes electrical connection between an electrically conductive retainer, fuel regulator and fuel pump sheath leading to vehicle ground. As seen in FIGS. 1 and 2 of the '671 patent, the vertical supply and fill tubes 42, 44 are integrally formed with the reservoir 14 and are hence made of the same, non-conductive plastic material. A jet pump 46 attaches to the fill tube 44 at the bottom of the reservoir. Integration of the tubes 42, 44 into the reservoir 14 in the '671 device allowed quality and cost savings to be realized due to the elimination of additional components and possible paths for leakage. Integration of the tubes with the reservoir also provided a low pick-up point for the jet pump allowing the jet pump to aspirate and pump all the fuel in the tank.

Since the time of the '671 patent, it is now required that the vertical return and fill tubes themselves be electrically conductive and/or dissipative. One solution would be to make the integrally formed reservoir and tubes of the '671 device from an electrically conductive plastic material, however, this would undesirably add to material cost. Conductive plastic is more expensive than non-conductive plastic and there is no requirement for the reservoir walls to be conductive and/or dissipative. Therefore, there exists a need for an improved MFR having conductive and/or dissipative supply and fill tubes and which maintains a low pick-up point for the jet pump and does not sacrifice cost and quality.

### SUMMARY OF THE INVENTION

The present invention addresses the above need by providing an improved MFR having a reservoir and retainer for locating the pump and fuel filter in the reservoir. The reservoir includes a bottom wall leading to an inner, vertically extending wall structure defining an open, vertical column extending from an opening in the bottom wall to an opening located adjacent or just below the top perimeter of the reservoir. The reservoir may be made of non-conductive plastic, for example. The retainer is made from an electrically conductive material such as, for example, an electrically conductive resin. The retainer is configured to attach to the top perimeter of the reservoir and securely locate the pump, filter and other desired components in the reservoir. The retainer further includes integrally formed vertical supply and fill tubes which are received within the open vertical column of the reservoir with the open bottom ends of the tubes exposed at the bottom opening of the reservoir column for attachment of a jet pump thereto. A low pick-up point for the jet pump is therefore maintained in the inventive design. The retainer and vertical supply and fill tubes are preferably integrally molded in one piece from the same conductive material.

### BRIEF DESCRIPTION OF THE DRAWING

The present invention will now be described, by way of example, with reference to the accompanying drawings, in which:

FIG. 1 is a side elevational view of a modular fuel reservoir according to the invention in a vehicle fuel tank;

FIG. 2 is an exploded perspective view of the modular fuel reservoir of FIG. 1; and

FIG. 3 is an elevational view of the fuel tank and reservoir and other components assembled therein with certain parts shown in section as taken generally along the line 3-3 in FIG. 1.

### DETAILED DESCRIPTION OF THE PREFERRED EMBODIMENT

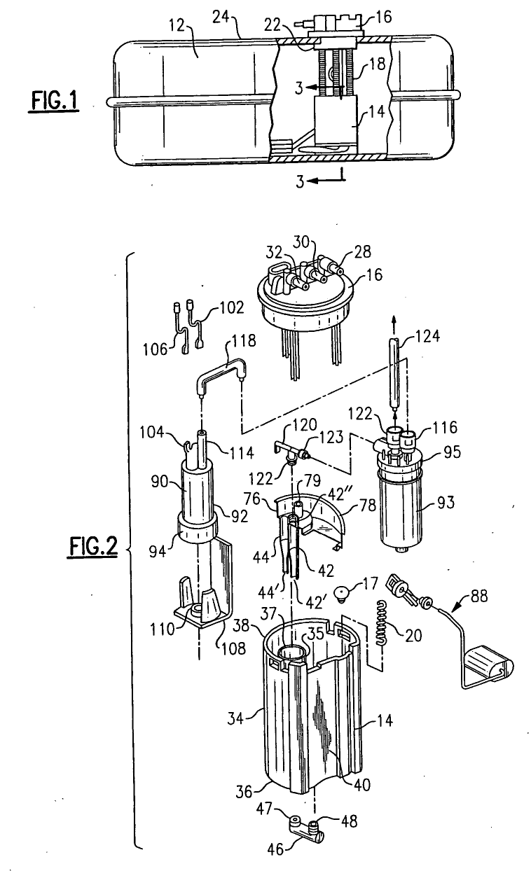

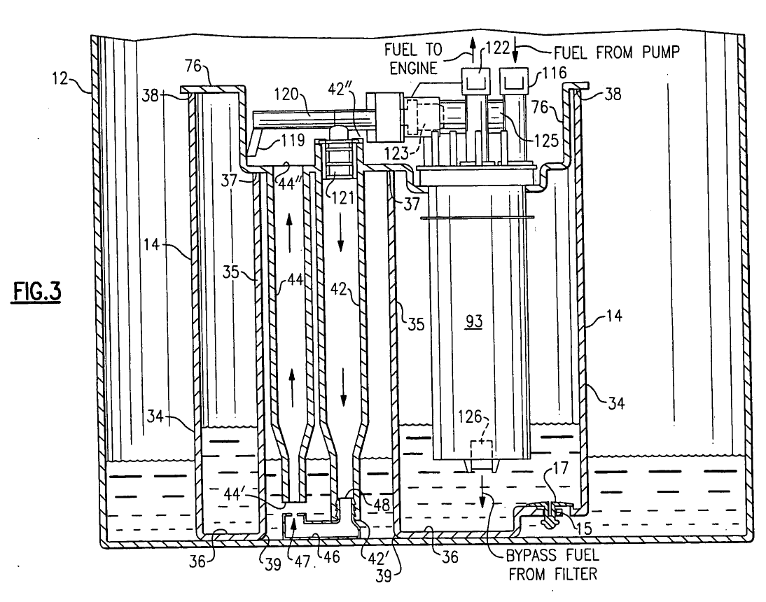

A seen best in FIGS. 1-2, a modular fuel reservoir (MFR) 10 according to this invention is disposed in a motor vehicle fuel tank 12. MFR 10 includes a reservoir 14, a tank cover 16, a plurality of vertical guide rods 18 on the tank cover slidably connected to the reservoir, and a spring 20 urging relative separation between the tank cover and the reservoir. The tank cover 16 seals closed an access port 22 in a top 24 of the fuel tank through which the MFR 10 may be inserted into the tank. The spring 20 biases the reservoir 14 against a bottom 26 of the fuel tank. A discharge fluid connector 28 and a return fluid connector 30 on the tank cover 16 are linked by external fluid conduits to the motor vehicle engine (not shown). A vapor connector 32 on the tank cover is also linked by an external conduit to a vapor storage device on the vehicle (not shown).

Reservoir 14 includes a side wall 34 and a bottom wall 36 leading inwardly to an open, vertically extending wall structure defining a column 35 having an open top defined by the column top edge 37, and an open bottom defined by the column bottom edge 39. Reservoir 14 is open at a top edge 38 thereof, and optionally flattened on a side wall 40 thereof to assist in securing any desired additional components thereto.

A retainer 76 of the MRA 10 (shown in section in FIG. 2) includes a wall structure 78 configured for removably attaching retainer 76 to the top edge 38 of reservoir 14. The retainer 76 also includes integrally formed vertical return and fill tubes 42, 44 each terminating at an open bottom end 42′, 44′, respectively. Preferably, tubes 42 and 44 extend in substantially spaced, parallel relation to one another. Retainer 76 seats on the reservoir 14 at the top edge 38 of the cylindrical wall 34 with tubes 42 and 44 extending freely through column 35 as seen in FIG. 3. In the fully attached condition of the retainer and reservoir, the open bottom ends 42′, 44′ of tubes 42, 44 are exposed and lie adjacent the bottom wall 36 of reservoir 14 in the opening defined by the bottom edge 39 of column 35. Retainer 76 may include additional integrally formed structures for securely locating other components, such as fuel pump 90 and fuel filter 92, in reservoir 14. A fuel level transducer 88 may also be attached to the retainer or reservoir. Retainer 76 may further include a port 79 (FIG. 2) for connecting a vapor venting hose (not shown) to vapor venting port 32 in cover 16.

A venturi jet pump 46 includes an inlet port 48 which connects to open bottom end 42′ of supply tube 42 adjacent reservoir bottom wall 36 (see FIG. 3). Jet pump 46 further includes an orifice 47 aimed at the open bottom end 44′ of fill tube 44 providing a fluid path between supply tube 42 and fill tube 44 as explained more fully below.

Retainer 76, including integrally formed tubes 42 and 44, is formed (e.g., by injection molding) as a unitary piece from an electrically conductive material such as, for example, Celcon EC90PLUS, an acetal copolymer available commercially from Ticona, a division of Celanese Corporation. A fuel pump 90 of the MFR 10 (see FIG. 2—not seen in FIG. 3) includes an exposed tubular shell 92 made of an electrically conductive material, e.g. steel or aluminum, a bottom end housing 94 made of an electrically non-conductive material, e.g. plastic, closing an end of the metal shell, and an electric motor (not shown) in the metal shell. A positive contact terminal of the pump motor (not shown) is connected to the wiring harness of the motor vehicle through a positive conductor 102 between the fuel pump 90 and the tank cover 16. A negative contact terminal 104 of the pump motor is electrically insulated from the positive contact terminal and connected to the wiring harness of the motor vehicle through a negative conductor 106 between the fuel pump 90 and the tank cover 16. The negative contact terminal 104 is in electrical communication with the metal shell 92 of the fuel pump through an internal conductor (not shown) in the fuel pump.

The fuel pump 90 is supported outside of the tubular chamber 35 on a fuel strainer 108 having an opening 110 that aligns with a fuel inlet (not shown) at the bottom end housing 94 of the pump 90. The retainer 76 bears directly against the metal shell 92 of the fuel pump 90 and establishes an electrically conductive interface therebetween. A discharge passage 114 extending from the fuel pump is connected to the fuel inlet 116 on fuel filter 93 via conduit 118.

Thus, when the electric motor of the fuel pump 90 is on, pump 90 pumps fuel from the reservoir 14 to the fuel filter 93. The fuel passes through the filter 93 and exits at outlet 122, continuing through conduit 124 to discharge fluid connector 28 on cover 16, ultimately leading to the vehicle engine. A pressure control valve 126 is positioned near the bottom wall of filter 93 to allow excess fuel to flow through outlet 128 back into reservoir 14. In this way, valve 126 ensures proper pressure is maintained in the fuel lines.

Fuel may be drawn into the reservoir 14 in the following additional ways. First, a feed connector 120 includes a fitting 121 which press fits into the open top end 42″ of supply tube 42. The opposite end 123 thereof fits into a connector 125 which taps into fuel inlet 116 of fuel filter 93. Thus, as fuel is pumped to the fuel filter inlet 116, a fraction of the fuel is diverted through the feed connector 120 and into the supply tube 42. The diverted fuel in the supply tube 42 enters the motive fluid inlet 48 of the jet pump and is discharged into the fill tube 44 as a jet which acts to aspirate fuel from the fuel tank 12 into the reservoir 14 to maintain the reservoir filled with fuel until the fuel tank is completely depleted. Fuel traveling through fill tube 44 is ejected at the top opening 44″ thereof, striking deflector 119 of connector 120 and is thereby directed back into reservoir 14. Fuel may also enter reservoir 14 through inlet 15 located at the bottom wall 36 thereof. An umbrella valve 17 is located at inlet 15 and operates by passively opening due to the head pressure differences in the fuel tank 12 and reservoir 14, and closing when head pressure in reservoir 14 exceeds pressure in fuel tank 12. Valve 17 is required for initial vehicle starts to get the fuel into the reservoir before the system is primed.

In the fully assembled condition of the MFR 10, all electrically conductive parts are grounded through pump 90 to which conductors 102, 106 attach as explained above. In the preferred embodiment, this is accomplished through mutual contact of the conductive parts. Thus, retainer 76 (including integral tubes 42, 44), which itself is made of an electrically conductive material, makes contact with the pump metal shell 92 and is therefore both conductive and grounded. Jet pump 46 is also formed of an electrically conductive material and makes contact with tube 42. Jet pump 46 is therefore also both conductive and grounded. Fuel filter 93 includes a conductive outer shell and end cap 95 which contacts the retainer 76. Filter 93 is therefore also both conductive and grounded. The fuel conduit and connectors 118, 120, 124, 116 and 122 are also all formed of a conductive material and, since they all make contact with fuel filter end cap 95, are all both conductive and grounded. All required and appropriate electrical grounding is therefore maintained by MFR 10.

What is claimed is:

1. A retainer for attaching to a reservoir of a modular reservoir assembly, said retainer having a lid and a supply tube and a fill tube extending from said lid, said lid and tubes being integrally formed from an electrically conductive material.

2. The retainer of claim 1 wherein said supply and fill tubes extend in substantially spaced, parallel relation to each other.

3. The retainer of claim 1 wherein said material is an electrically conductive resin.

4. The retainer of claim 1 wherein said lid is configured to locate a fuel pump in said reservoir.

5. A modular fuel reservoir assembly, comprising:
a) a reservoir having a bottom wall leading to an internal, vertical wall structure defining an open vertical column;
b) a retainer for attaching to said reservoir, said retainer having a lid and a supply tube and a fill tube extending from said lid, said lid and tubes being integrally formed from an electrically conductive material, said tubes freely extending through said vertical column when said retainer is attached to said reservoir.

6. The assembly of claim 5 wherein said tubes each include open top and bottom ends, said bottom ends of which are exposed and lie adjacent to said reservoir bottom wall when said retainer is attached to said reservoir.

7. The assembly of claim 6 and further comprising a jet pump attached to said supply tube adjacent said bottom wall of said reservoir.

8. The assembly of claim 7 wherein said jet pump is formed of an electrically conductive material.

9. The assembly of claim 8 and further comprising a fuel pump and a fuel filter positioned in said reservoir and conduit extending from said pump to a fuel inlet on said filter.

10. The assembly of claim 9 wherein at least a part of said fuel pump and said fuel filter is conductive and in conductive contact with said retainer.

11. The assembly of claim 10 wherein said filter includes a pressure control valve operable to release excess fuel from said filter and into said reservoir.

12. The assembly of claim 11 and further comprising a feed connector (120) having a first end (121) connected to said open top end of said supply tube (42), said feed connector having an opposite, second end (123) connected to said fuel inlet (116) of said fuel filter such that as fuel is pumped from said fuel pump to said fuel filter inlet, a fraction of the fuel is diverted through said feed connector and into said supply tube (42).

13. The assembly of claim 12 and further comprising a tank cover, a plurality of vertical guide rods on the tank cover slidably connected to said reservoir, and a spring urging relative separation between said tank cover and said reservoir.

14. The assembly of claim 13 and further comprising a fuel tank having a top, bottom and side walls wherein said assembly may be positioned with said tank cover sealing closed an access port in said top of said fuel tank, said spring biasing said reservoir against said bottom wall of said fuel tank.

15. The assembly of claim 13 and further comprising a discharge fluid connector and a return fluid connector on said tank cover
